(19) United States
(12) Patent Application Publication
(10) Pub. No.: US 2020/0130899 A1
(43) Pub. Date: Apr. 30, 2020

(54) PROFILE VALVE FOR LIQUID METERING AND DISPENSING

(71) Applicant: ILLINOIS TOOL WORKS INC., Glenview, IL (US)

(72) Inventors: Christopher LUDWIG, Buffalo Grove, IL (US); Murray Edward Bruce LEIGHTON, North Yorkshire (GB)

(21) Appl. No.: 16/606,348

(22) PCT Filed: Apr. 19, 2018
(86) PCT No.: PCT/US2018/028327

§ 371 Date: Oct. 18, 2019

Related U.S. Application Data
(60) Provisional application No. 62/487,608, filed on Apr. 20, 2017.
(60) Provisional application No. 62/487,598, filed on Apr. 20, 2017.
(60) Provisional application No. 62/500,123, filed on May 2, 2017.
(60) Provisional application No. 62/490,258, filed on Apr. 26, 2017.
(60) Provisional application No. 62/490,686, filed on Apr. 27, 2017.
(60) Provisional application No. 62/545,229, filed on Aug. 14, 2017.

(51) Int. Cl. B65D 35/40; G01F 11/08; B65D 33/25

(52) U.S. Cl. CPC B65D 35/40; B65D 33/2508; G01F 11/082

(57) ABSTRACT

A flexible container, bottle or bag with a one-way valve adjacent to a pressure close tight or bubble valve, operating as a dispensing valve, in order provides a metered dosing element. The dispensing valve for flexible packaging, using an extruded profile as a valve which requires internal pressure to overcome the seal effect or bias of the profile alows for metering of the contents of a flexible package.

This application claims priority of U.S. Provisional Application Ser. No. 62/487,608, filed on Apr. 20, 2017; U.S. Provisional Application Ser. No. 62/487,598, filed on Apr. 20, 2017; U.S. Provisional Application Ser. No. 62/500,123, filed on May 2, 2017; U.S. Provisional Application Ser. No. 62/490,258, filed on Apr. 26, 2017; U.S. Provisional Application Ser. No. 62/490,686, filed on Apr. 27, 2017; and U.S. Provisional Application Ser. No. 62/545,229, filed on Aug. 14, 2017, the contents of the disclosure of all of which are incorporated by reference herein for all purposes.

### BACKGROUND OF THE DISCLOSURE

### Field of the Disclosure

The present disclosure relates to a flexible container, bottle or bag with a one-way valve adjacent to a pressure close tight or bubble valve, operating as a dispensing valve, in order to provide a metered dosing element. The present disclosure further relates to a dispensing valve for flexible packaging, using a profile as a valve which requires internal pressure to overcome the seal effect or bias of the profile thereby allowing for metering of the contents of a flexible package.

### DESCRIPTION OF THE PRIOR ART

Prior art packaging in the food/beverage, personal care and household care industries is primarily a combination of a rigid bottle or semi-flexible tube with a rigid fitment or cap of varying dispense types. Transition to flexible pouches for the main body of the container has continued to utilize similar, still rigid, fitments. There exists a need within these industries to complete the transition in order to create a fully flexible solution.

Prior art embodiments of a plastic valve for flexible pouches required many manufacturing steps, material, and time. First, a rectangular pocket of ambient air is trapped between two sheets of plastic film. Then the pocket is repeatedly condensed in footprint by the use of successive heat seals on pouch making equipment. Reduction of the area gradually increases the amount of internal pressure within the formed bubble. There exists a need for a method of manufacturing a bubble in flexible packaging using less manufacturing steps, material, and time.

The prior art includes U.S. Pat. No. 8,613,547 entitled “Packages Having Bubble-Shaped Closures”; U.S. Pat. No. 7,883,268 entitled “Package Having a Fluid Activated Closure”; U.S. Pat. No. 7,207,717 entitled “Package Having a Fluid Activated Closure”; U.S. Published Application 2016/0297571 entitled “Package Valve Closure System and Method”; U.S. Published Application 2011/0200275 entitled “Package Containing a Breachable Bubble in Combination with Closure Device”; PCT/US2015/058030 entitled “Closure for a Reclosable Package with an Air Pocket Formed on a Flange”; and European Patent Application EP 1 812 318 B1 entitled “Package Having a Fluid Actuated Closure.”

A related application is PCT/US17/61500 entitled “Bubble Valve for Flexible Packaging.”

### OBJECT AND SUMMARY OF THE DISCLOSURE

It is therefore an object of the present disclosure to provide a profile on a web of film to create a pressure-activated dispensing valve which is easy to manufacture and which can be applied with known applicator designs.

It is therefore a further object of the present disclosure to provide an improved valve, including metering and dispensing, for customer applications. These and other objects are attained by providing a valve made of a channel and typically one or two bubble valves that can be attached to a flexible package to enable the controlled release of products by means of applying pressure. Embodiments with a single bubble may further include a one-way non-bubble valve to introduce product or contents into a dispensing chamber, for subsequent dispensing of a metered amount of product through the single bubble valve.

In a presently contemplated valve for permitting selective metering and dispensing of contents of a package, bubble valves are made of at least three layers—a channel layer (typically formed from a first or front co-extensive polymeric panel), at least one bubble layer or interior layer, and a base layer (typically formed from a second or rear co-extensive polymeric panel) Bubbles are formed between the base layer and the bubble layer. Channels are formed between the bubble layer and the channel layer. A physical characteristic of the bubbles biases the channels towards a closed position that restricts flow of contents from the inlet to the outlet.

In a presently contemplated method of forming a bubble valve, a bubble is formed between the base layer and the bubble layer by applying a bubble seal between the layers and enclosing an enclosed material in the bubble. A channel is formed between the bubble layer and the channel layer. The channel includes an inlet and an outlet. The bubble includes a physical characteristic that restricts flow of contents from the inlet to the outlet.

In a presently contemplated package for retaining and dispensing contents to a user, the package includes a one-way valve and a dispensing valve, with a metering volume therebetween. The dispensing valve may be configured as a first bubble valve, and the one-way valve may be configured as a second bubble valve or as another configuration of a valve. The internal volume is defined between a rear panel portion and a front panel portion, and between the one-way valve and the dispensing valve.

### BRIEF DESCRIPTION OF THE DRAWINGS

Further objects and advantages of the disclosure will become apparent from the following description and from the accompanying drawings, wherein:

FIG. 1 is a side plan view of a container with an embodiment of the profile valve of the current disclosure.

FIG. 2 is a detailed view of a portion of FIG. 1.

FIG. 3 is a cut-away view of an embodiment of the profile valve of the current disclosure.

FIG. 4 is an end plan view of a container with an embodiment of the profile valve of the current disclosure.

FIG. 5 is a detailed view of a portion of FIG. 4.

FIG. 6 is a cut-away view of a first alternative embodiment of the profile valve of the current disclosure.

FIG. 7 is a cut-away view of a second alternative embodiment of the profile valve of the current disclosure.

FIG. 8 is a cut-away view of a third alternative embodiment of the profile valve of the current disclosure.

FIG. 9 is a cut-away view of a fourth alternative embodiment of the profile valve of the current disclosure.

FIG. 10 is a cut-away view of a fifth alternative embodiment of the profile valve of the current disclosure.

FIG. 11 is a cut-away view of a sixth alternative embodiment of the profile valve of the current disclosure.

### DETAILED DESCRIPTION OF THE PREFERRED EMBODIMENTS

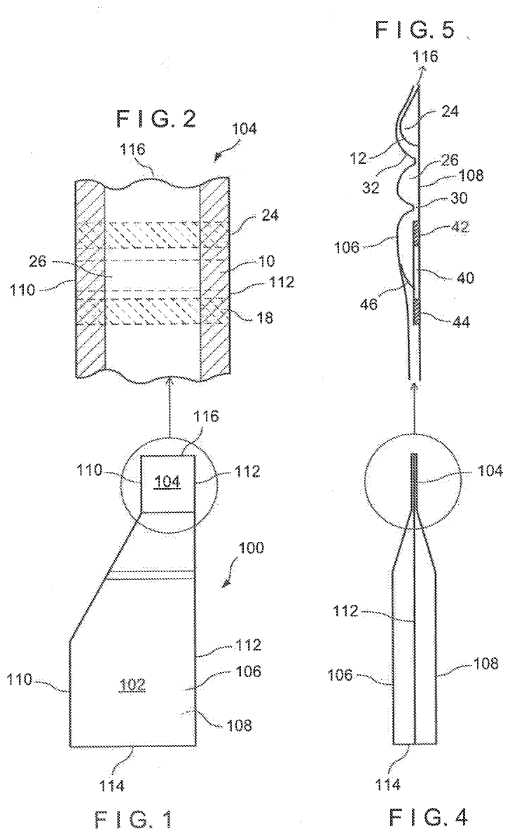

Referring now to the drawings in detail, wherein like numerals indicate like elements through the several views, one sees that FIGS. 1-2 illustrate an embodiment of a package or pouch 100 utilizing the one-way metering valve structure 10 of the present disclosure. The illustrated pouch 100 includes a lower enlarged storage volume 102 and an upper neck (or storage access portion) 104, typically formed from first and second co-extensive sheets of polymeric material 106, 108 forming first and second panel portions. The interior of upper neck 104 houses the metering valve structure 10 and further provides a pathway from the storage volume 102 to the exterior of the package 100. As shown in FIG. 2, vertical seals 110, 112 seal together the edges of first and second polymeric sheets 106, 108 and the edges of the metering valve structure 10. A bottom seal (or fold) 114 joins the lower edges of the first and second polymeric sheets 106, 108 to form the lower boundary of the lower enlarged storage volume 102. At the uppermost portion of upper neck 104, the portions of first and second co-extensive sheets of polymeric material 106, 108 between first and second side seals 110, 112 are not sealed together in the area, thereby forming a dispensing mouth 116, with exiting flow controlled by metering valve structure 10. Many products may be held within storage volume 102 and dispensed through dispensing mouth 116, including, but not limited to, clothes washer detergents or concentrated cleaners, particularly those which need to be measured and added to water prior to use.

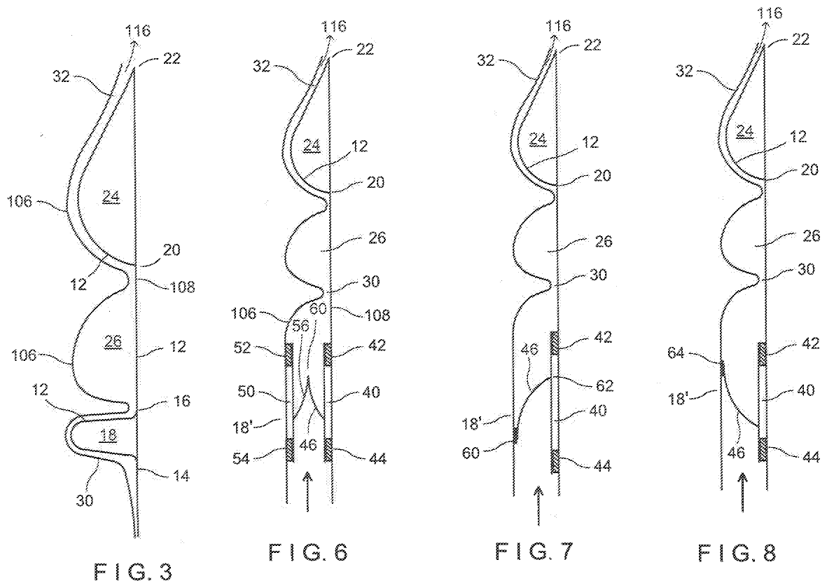

As best illustrated in FIG. 3, the second or rear polymeric sheet 108 forms the base layer of the one-way metering valve structure 10. A bubble film layer 12 is sealed to the base film layer (alternately referred to as the second or rear polymeric sheet, however some embodiments may have a bubble film layer which is separate from the second or rear polymeric sheet) 108 at the product side metering bubble seam 14 and the consumer side metering bubble seam 16 thereby allowing the bubble film layer 12 to form a one-way metering bubble 18 configured as a protruding closure device, which is filled with air or another gas, fluid or liquid. The bubble film layer 12 is further included within the first and second side seals 110, 112 along the length of metering valve structure 10. As shown in FIG. 2, the metering bubble 18 extends from the first side seal 110 to the second side seal 112.

Bubble film 12 continues along base film layer 108 and is sealed to base film layer 108 at product side dispensing bubble seam 20, and further sealed to bubble film layer 108 to form consumer side dispensing bubble seam 22. Dispensing bubble 24 is bounded between the base film layer 108 and the bubble film layer 12, between the product side dispensing bubble seam 20 and the consumer side dispensing bubble seam 22, and between the first and second side seals 110, 112, thereby allowing the bubble film layer 12 to form dispensing bubble 24 (configured as a pressure close tight valve and a protruding closure device), which is filled with air or another gas, fluid or liquid.

The bubbles 18, 24 include an enclosed material. The enclosed material is trapped between the base film layer 108 (i.e., a first exterior layer) of film and the bubble film layer 12 (i.e., at least one interior layer) of film to create the bubbles 18, 24 of a desired shape and size. In some embodiments, the enclosed material is a gas or a liquid. In such embodiments, the pressure of the liquid or the gas is a physical characteristic of the bubbles 18, 24 that biases the channel 14 from an open position towards a closed position. In one embodiment, the enclosed material is ambient air trapped during sealing of the layers 108, 12. In another embodiment, the enclosed material further includes added supplemental, pressurized, or inflated air. In yet another embodiment, the enclosed material inside the bubbles 18, 24 is a solid such as, for example, but not limited to, a urethane sponge or a rubber nub. In such embodiments, the elasticity of the solid imparts or affects a physical characteristic of the bubbles 18, 24. The shaping and dimensions of the bubbles 18, 24 and the film types of the layers 108, 12 can be customized to the specific needs of the product and/or consumer or user requirements. Such specific needs include, for example, but are not limited to, opening force of the valve structure 10, closing (i.e., shut-off) force of the valve 10, flow characteristics (i.e., opening/closing responsiveness) of the valve 10, and viscosity of contents (if liquid; solid contents are also possible) in a package.

As further shown in FIG. 3, the first or front polymeric sheet 106 forms the channel layer of the metering valve structure 10. The dispensing chamber 26 is defined between first or front co-extensive polymeric sheet 106 (i.e., channel layer) and bubble film layer 12 (in combination with second or rear co-extensive polymeric sheet 108 or base layer) generally between the metering bubble 18 and the dispensing bubble 24. That is, the entrance channel 30 to dispensing chamber 26 is formed between the metering bubble 18 and the channel film layer 106. Likewise, the exit channel 32 from dispensing chamber 26 to dispensing mouth 116 is formed between dispensing bubble 24 and channel film layer 106. A physical characteristic (e.g., inflation, pressure, height, or elasticity) of the metering bubble 18 and the dispensing bubble 24, along with the tautness of the film layers 12, 106, 108 induced by the first and second side seams 110, 112, urges the metering bubble 18 and dispensing bubble 24 in a straight unbent configuration and further urges the channel layer 106 in a taut configuration against the metering bubble 18 and the dispensing bubble 24 so that consumer product is not dispensed in the absence of external force. Additionally, the material forming the dispensing chamber 26 on first or front co-extensive polymeric sheet 106 may be of increased stiffness in order to bias the dispensing chamber 26 toward its illustrated shape. Thermoforming of this material, along with partial sealing of the first or front co-extensive polymeric sheet 106 may be used in some embodiments.

Additionally, gradation lines to be used as a ruler or meter, may be added to the first and/or second polymeric sheets 106, 108 within the area of the dispensing chamber 26 in order to allow the user to determine or approximate the amount of product in dispensing chamber 26.

In order to dispense product from the lower enlarged storage volume 102 through dispensing mouth 116, the user would first apply pressure to the product from lower enlarged storage volume 102 into dispensing chamber 26 by squeezing lower enlarged storage volume 102 thereby creating enough pressure to urge a metered amount of product through entrance channel 30 (overcoming the bias of the metering bubble 18 to otherwise form a closed configuration with channel layer 106) into dispensing chamber 26, as illustrated in phantom in FIG. 3. The flow of the consumer product would be stopped by metering dispensing bubble 24 due to the physical characteristics (e.g., inflation, pressure, height, or elasticity) of the metering and dispensing bubbles 18, 24 and the tautness of the film layers 12, 106, 108 induced by the first and second side seams 110, 112. Then, in order to dispense product from dispensing chamber 26 through exit channel 32 and finally through dispensing mouth 116, the user would squeeze the dispensing chamber 26 directly thereby creating enough pressure to overcome the bias of the dispensing bubble 24 to otherwise form a closed configuration with the channel layer 106. This forces the metered amount of consumer product through exit channel 32 and thereby through dispensing mouth 116.

Alternative embodiments are illustrated in FIGS. 5-11 wherein the one-way metering bubble 18 is replaced by an alternative metering structure which is typically configured as a substantially one-way valve. In the alternative embodiment illustrated in FIG. 5, metering structure 18′ comprises a vertical flange 40 which is sealed at first and second ends 42, 44 to the second sheet of polymeric material 108 (or base film layer). A sealing lip 46 extends from vertical flange 40 and presses against the first sheet of polymeric material 106.

In the alternative embodiment illustrated in FIG. 6, metering structure 18′ comprises a first vertical flange 40 which is sealed at first and second ends 42, 44 to the second sheet of polymeric material 108 (or base film layer) thereby forming a first profile and a second vertical flange which is sealed at first and second ends 52, 54 to the first sheet of polymeric material 106 (or channel layer) thereby forming a second profile. A first sealing lip 46 extends from first vertical flange 40 and a second sealing lip 56 extends from second vertical flange 50 whereby the distal ends of first and second sealing lips 46, 56 could be frangibly joined together at apex 60.

In the alternative embodiment illustrated in FIG. 7, sealing lip 46 is sealed to first sheet of polymeric material 106 (or channel layer) at sealing point 60 and could be frangibly joined to vertical flange 40 at point 62.

In the alternative embodiment illustrated in FIG. 8, the structure is similar to that of FIG. 5, except that a peel seal 64 could frangibly join the distal end of sealing lip 46 to the first sheet of polymeric material 106 (or channel layer).

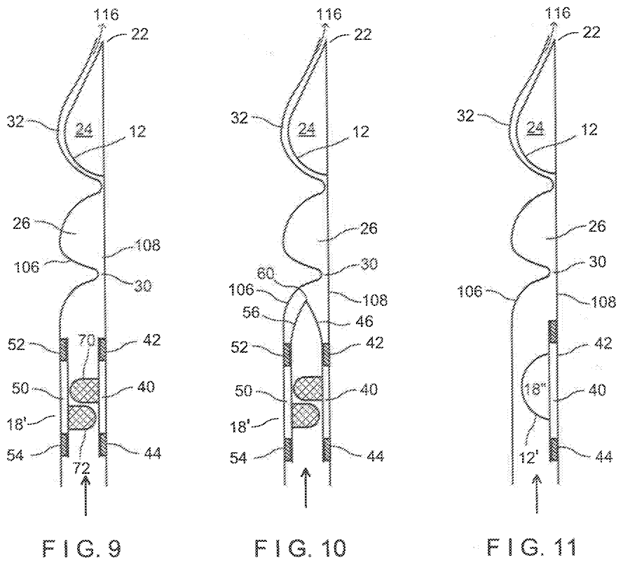

In the alternative embodiment illustrated in FIG. 9, first and second semi-rigid profiles 70, 72 are attached to respective first and second vertical flanges 40, 50. The first and second semi-rigid profiles 70, 72 are somewhat vertically offset (in the illustrated orientation) from each other and press against each other to provide the desired one-way valve function.

In the alternative embodiment illustrated in FIG. 10, first and second sealing lips 46, 56 extend from respective first and second semi-rigid profiles 70, 72 whereby the distal ends of first and second sealing lips 46, 56 could be frangibly joined together at apex 60.

The alternative embodiment illustrated in FIG. 11 is similar in structure and function to the embodiment of FIG. 3. The one-way metering bubble 18” is formed by attaching a bubble layer segment 12′ to the vertical flange 40, wherein the vertical flange 40 is sealed to the second sheet of polymeric material 108 (or base film layer) at first and second ends 42, 44. This configuration of one-way metering bubble 18” is particularly adapted to formation with a torpedo extrusion die (not shown).

A possible method and apparatus for manufacturing the valve structure 10 is described herein. Additional details can be drawn from related application PCT/US17/61500, entitled “Bubble Valve for Flexible Packaging.” The polymeric or similar sheet material for the base film layer 108, bubble film layer 12, and channel film layer 106 are provided by unwinds or spools. The metering bubble 18 and the dispensing bubble 24 are formed by a first thermoformer in at least the bubble layer 12. In one embodiment, the bubbles 18, 24 are formed using both vacuum forming and thermoforming processes. The shaping and dimensions of the bubbles 18, 24 using vacuum forming and/or thermoforming processes can be customized to the specific needs of the product and/or consumer or user requirements. Such specific needs include, for example, but are not limited to, opening force and speed of the valve structure 10, closing (i.e., shut-off) force and speed of the valve 10, and viscosity of contents (if liquid; solid contents are also possible) in a package.

The dispensing chamber 26 is formed by a second thermoformer in at least the channel film layer 106. In some embodiments, the dispensing chamber 26 is formed from a thicker film than the metering bubble 18 and the dispensing bubble 24. The bubbles 18, 24 are made of, for example, but not limited to, polyethylene and/or polypropylene or a combination thereof; the dispensing chamber is formed from, for example, but not limited to, silicone.

The polymeric or similar sheet material for the base film layer 108 is sealed to the bubble film layer 12 by a first ultrasonic sealer (i.e., applying bubble seal). The polymeric or similar sheet material for the channel film layer 106 is sealed to the combination of the layers 108, 12 by a second ultrasonic sealer 316 (i.e., applying channel seal).

Thus, the several aforementioned objects and advantages are most effectively attained. Although preferred embodiments of the invention have been disclosed and described in detail herein, it should be understood that this invention is in no sense limited thereby.

What is claimed is:

1. A package for holding and dispensing a metered contents, comprising:
a first panel portion made of flexible material;
a second panel portion made of flexible material, the first panel and the second panel defining a storage volume;
a storage access portion, defined by a portion of the first and second panel portions, defining a flow pathway for communicating from the storage volume to an exterior of the package;
the storage access portion including a dispensing chamber defined by a first valve on a product side of the dispensing chamber and a second valve on a consumer side of the dispensing chamber;
the first valve being substantially a one-way valve which passes contents from the storage volume to the dispensing chamber upon application of pressure to a portion of the package; and
the second valve passing contents from the dispensing chamber through a portion of the flow pathway to an exterior of the package upon application of pressure to the dispensing chamber.

2. The package of claim 1 wherein the storage access portion is narrower than the storage volume.

3. The package of claim 2 wherein the first valve is a first protruding closure device.

4. The package of claim 3 wherein the first protruding closure device contains a first bubble containing a first fluid.

5. The package of claim 4 wherein the first fluid is a gas.

6. The package of claim 3 wherein the second valve is a second protruding closure device.

7. The package of claim 6 wherein the second protruding closure device contains a second bubble containing a second fluid.

8. The package of claim 7 wherein the second fluid is a gas.

9. The package of claim 6 wherein a bubble layer of film is positioned between the first and second panel portions within the storage access portion, the bubble layer being sealed to at least one of the first and second panel portions thereby forming the first and second bubbles.

10. The package of claim 9 wherein the first and second bubbles impinge against at least one of the first and second panel portions.

11. The package of claim 2 wherein the first valve includes:
a first profile with a first flange and a first sealing lip extending from the first flange;
a second profile with a second flange and a second sealing lip extending from the second flange;
wherein distal ends of the first and second sealing lips are joined together at an apex.

12. The package of claim 11 wherein the first profile is attached to a first of the first and second profile panel portions and the second profile is sealed to a second of the first and second profile panel portions.

13. The package of claim 12 wherein the apex points toward a consumer side of the package.

14. The package of claim 2 wherein the first valve includes:
a profile with a flange and a sealing lip extending from the flange;
the profile being sealed to a first of the first and second profile panel portions and the sealing lip being joined to a second of the first and second profile panel portions.

15. The package of claim 14 wherein the sealing lip is joined to the second of the first and second profile panel portions by a peel seal.

16. The package of claim 14 wherein the sealing lip is joined to the second of the first and second profile panel portions by a frangible connection.

17. A valve structure, comprising:
a fluid flow path from a first end of the valve structure to a second end of the valve structure;
the flow path including a first valve on a first end of the valve structure and a second valve on the second end of the valve structure;
a dispensing chamber defined between the first valve and the second valve;
the first valve being substantially a one-way valve which passes contents from the first end of the valve structure to the dispensing chamber; and
the second valve passing contents from the dispensing chamber through a portion of the flow pathway to the second end of the valve structure upon application of pressure to the dispensing chamber.

18. The valve structure of claim 17 wherein the first valve is a first protruding closure device.

19. The valve structure of claim 18 wherein the first protruding closure device contains a first bubble containing a first fluid.

20. The valve structure of claim 19 wherein the first fluid is a gas.

21. The valve structure of claim 18 wherein the second valve is a second protruding closure device.

22. The valve structure of claim 21 wherein the second protruding closure device contains a second bubble containing a second fluid.

23. The valve structure of claim 22 wherein the second fluid is a gas.

24. The valve structure of claim 17 wherein the first valve includes:
a first profile with a first flange and a first sealing lip extending from the first flange;
a second profile with a second flange and a second sealing lip extending from the second flange;
wherein distal ends of the first and second sealing lips are joined together at an apex.

25. The valve structure of claim 24 wherein the apex points toward the second end of the valve structure.

26. The valve structure of claim 17 wherein the first valve includes:
a profile with a flange and a sealing lip extending from the flange.

27. The valve structure of claim 26 wherein a distal end of the sealing lip includes a peel seal.

28. A method of forming a valve through which a user may dispense contents from an internal volume of a package, said method comprising:
forming a first bubble and a second bubble between a first exterior layer and a first interior layer by applying a bubble seal between said first exterior layer and said first interior layer and enclosing an enclosed material in said first bubble and said second bubble;
forming a dispensing chamber between said first bubble and said second bubble; and
forming a channel between said second exterior layer and one of said first interior layer and said first exterior layer by applying a channel seal between said second exterior layer and one of said first interior layer and said first exterior layer, said channel including an inlet for fluidic communication with said internal volume and an outlet through which said contents may be dispensed,
wherein said first interior layer is disposed between said exterior layers,
wherein said first bubble and said second bubble include a physical characteristic that restricts flow of said contents from said inlet to said outlet.

29. The method of claim 28 further comprising attaching said valve to said package at an attachment section located on at least two of said layers.

30. The method of claim 28 wherein said enclosed material is a gas or a liquid.

31. The method of claim 30 wherein said gas is ambient air.

32. The method of claim 30 wherein said physical characteristic of said first bubble and said second bubble is a pressure of said gas or said liquid.

33. The method of claim 28 wherein said enclosed material is a solid.

34. The method of claim 28 further compromising thermoforming or vacuum forming said interior layers.
